(19) United States
(12) Patent Application Publication
(10) Pub. No.: US 2017/0009160 A1
(43) Pub. Date: Jan. 12, 2017

(54) SYSTEM FOR GASIFICATION OF SOLID WASTE AND METHOD OF OPERATION

(71) Applicant: KASHONG LLC, Hollywood, CA (US)

(72) Inventors: Matthew H. Fronk, Honeoye Falls, NY (US); Courtney E. Reich, Fairport, NY (US)

(21) Appl. No.: 14/792,668

(22) Filed: Jul. 7, 2015

(51) Int. Cl. C10J 3/72; C10J 3/82; H01M 8/06; C10K 1/10; C10K 1/16; C10G 2/00; C10K 1/00

(52) U.S. Cl. CPC C10J 3/723; C10G 2/30; C10J 3/82; C10K 1/007; C10K 1/008; C10K 1/002; C10K 1/004; C10K 1/005; C10K 1/101; C10K 1/16; H01M 8/0643; C10J 2200/09; C10J 2300/0946; C10J 2300/0959; C10J 2300/1659; C10J 2300/1646; C10J 2300/1846

(57) ABSTRACT

A system and method of producing syngas is provided. The system includes a low tar gasification generator that receives at least a first and second feedstock stream, such as a solid waste stream. The first and second feedstock streams are mixed and gasified to produce a first gas stream. An operating parameter is measured and a ratio of the first and second feedstock streams is changed in response to the measurement.

### BACKGROUND OF THE DISCLOSURE

The subject matter disclosed herein relates to a system for converting solid waste and in particular, to a system that controls the source of feedstock to improve syngas quality.

Traditionally, municipal solid waste was disposed of by dumping of the waste into the ocean, burning in incinerators or burying in landfills. Due to the undesired environmental effects (e.g. release of methane into the atmosphere and contamination of ground water) of these practices, many jurisdictions have prohibited their expansion or continued implementation. In some parts of the world, gasification technologies have been used to eliminate municipal waste.

Gasification is a process that decomposes a solid material to generate a synthetic gas, sometimes colloquially referred to as syngas. This syngas typically includes carbon monoxide, hydrogen and carbon dioxide. The produced syngas may then be burned to generate steam that drives large gas turbines (50 MW) or internal combustion engines to generate electricity. There are several technologies that are used, including an up-draft gasifier, a down-draft gasifier, a fluidized bed reactor, an entrained flow gasifier and a plasma gasifier. All gasifiers utilize controlled amounts of oxygen to decompose the waste. One issue with current systems is that the use of a gas turbine requires large amounts of waste and correspondingly large amounts of oxygen. As a result, these gasifiers have to be located close to areas where both the waste fuel and oxygen may be readily supplied in large volumes. Further, since steam is generated in the process, to maintain efficiencies the systems need to be located in major industrial complexes where the steam can be used in process or district heating systems.

Accordingly, while existing gasification to electrical power systems have been suitable for their intended purposes the need for improvement remains, particularly in providing a system that can operate at higher efficiency.

### BRIEF DESCRIPTION OF THE DISCLOSURE

According to one aspect of the disclosure a system for converting solid waste material to a syngas is provided. The system includes a feedstock module configured to receive at least a first feedstock stream and a second feedstock stream, the second feedstock stream being different than the first feedstock stream. The feedstock module being further configured to mix the first feedstock stream and the second feedstock stream at a first ratio to produce a first refuse derived feedstock. An input module having a low tar gasification generator is configured to produce a first gas stream in response to receiving the refuse derived feedstock, the first gas stream including hydrogen. A process module is fluidly coupled to receive the first gas stream, the process module including at least one clean-up process module configured to remove at least one contaminant from the first gas stream and produce a second gas stream containing hydrogen. A first sensor is arranged to measure a first operating parameter. A control system is coupled for communication to the feedstock module and the sensor, the control system having a processor responsive to executable computer instructions for changing the ratio of the first mixture of the first feedstock stream to the second feedstock stream to a second ratio in response to receiving the first parameter.

According to another aspect of the disclosure a method of producing syngas from a solid waste stream is provided. The method includes: receiving a first feedstock stream; receiving a second feedstock stream; mixing the first feedstock stream and the second feedstock stream to generate a refuse derived feedstock (RDF) stream, the RDF stream having a first ratio of the first feedstock stream to the second feedstock stream; transferring the RDF stream into a gasification generator; receiving an oxygen gas stream at the gasification generator; producing a first gas stream and residual materials using the gasification generator; measuring a first operating parameter associated with the first gas stream; and changing the first ratio in response to measuring the first operating parameter.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a schematic diagram of a system for generating electrical power through the gasification of solid waste in accordance with an embodiment of the invention;

FIG. 2 is a schematic diagram of a feedstock module for use with the system of FIG. 1;

FIG. 3 is a schematic diagram of a gasifier module for use with the system of FIG. 1;

FIG. 4 is a schematic diagram of a process module for use with the system of FIG. 1, in accordance with an embodiment of the invention;

FIG. 5 is a schematic diagram of a process module for use with the system of FIG. 1, in accordance with another embodiment of the invention;

FIG. 6 is a schematic diagram of a power generation module for use with the system of FIG. 1; and

FIG. 7 is a flow diagram of a method of operating the system of FIG. 1.

The detailed description explains embodiments of the invention, together with advantages and features, by way of example with reference to the drawings.

### DETAILED DESCRIPTION OF THE DISCLOSURE

Embodiments of the invention provide advantages in the high efficiency generation of electrical power from solid waste, such as municipal waste. Embodiments of the invention provide advantages in controlling input feedstock streams to achieve a desired operating condition. In one embodiment, the ratio of a plurality of feedstock streams is changed to change the output temperature of a gas stream from a gasifier.

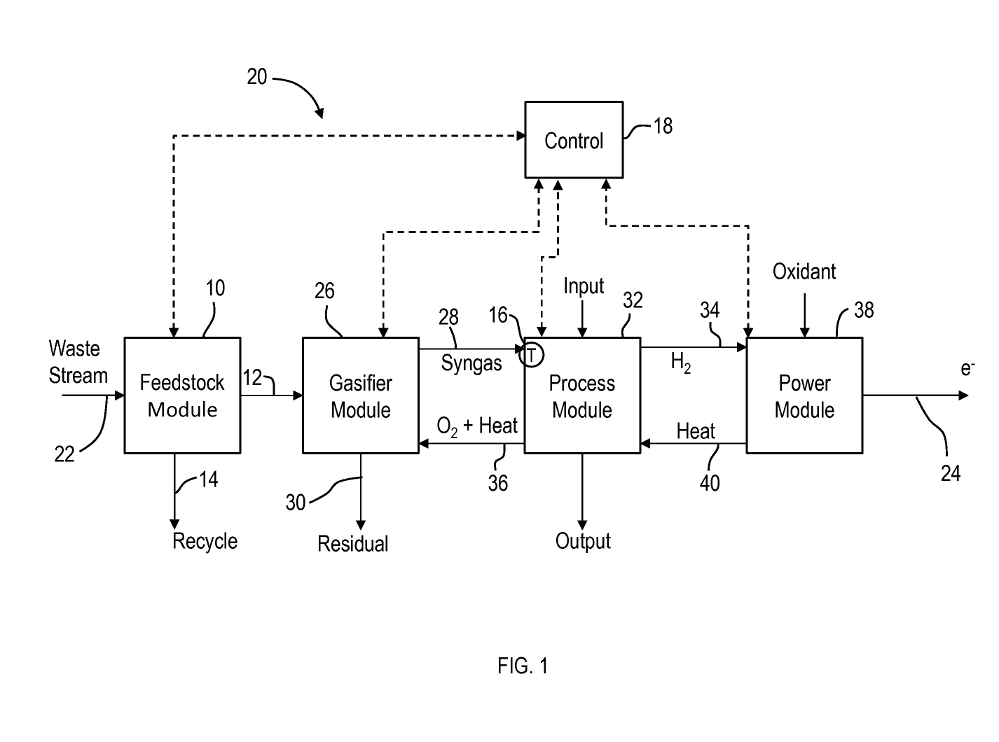

Referring now to FIG. 1, an exemplary system 20 is illustrated for converting a solid waste input stream 22 into generated electrical power 24. The system 20 includes a feedstock module 10 that receives the solid waste input stream 22 and outputs a refuse derived feedstock (RDF) 12 and optionally a recycling stream 14 (e.g. separated metals). The RDF 12 is received by a gasifer module 26 that produces a syngas 28 and a residual stream 30. The residual stream 30 may include slag (e.g. a mixture of metal oxides and silicon dioxide) and recovered metals. In one embodiment, the residual stream is recovered and recycled into the manufacture of other products, such as concrete for example. The syngas 28 is mainly comprised of hydrogen (H₂), carbon monoxide (CO) and Carbon Dioxide (CO₂) when oxygen gas is used as an input for the gasification process. Where air is used as an input, the syngas 28 may further include nitrogen or nitrogen compounds.

The syngas 28 is transferred from the gasifier module 26 to a process module 32. As will be discussed in more detail herein, the process module 32 modifies the syngas stream 28 to provide an output fuel stream 34 having an enhanced hydrogen content. To accomplish this, the process module 32 provides several functions, including the quenching of the syngas to reduce or avoid the formation of undesirable compounds (e.g. dioxins and furans), the removal of particulates and solids from the gas stream, and the removal of impurities or contaminants such as sulfur, nitrogen and carbon dioxide. The process module 32 further conditions the output fuel stream 34 to have the desired pressure, temperature and humidity so that it is suitable for downstream use.

As will be discussed in more detail herein, the process module 32 may include one or more sensors 16 that provide a signal indicating a measured operating parameter, such as syngas temperature for example. In one embodiment, the signal is transmitted to a control system 18, which uses the measured parameter in a closed loop feedback process to provide a desired operating condition, such as to control the input temperature, pressure or humidity of the syngas 28 to the process module 32 for example.

The process module 32 may include a number of inputs, such as but not limited to water, oxygen and solvents such as amine based solvents (e.g. Monoethanolamine). The oxygen input may be used to absorb thermal energy from the syngas 28. Thus, the oxygen stream 36 has an elevated temperature (200 C) when it is transferred to the gasifier module 26. Since the oxygen temperature is increased, the efficiency of the gasification is increased as well. In one embodiment, a steam loop may be used as a heat transfer medium between the syngas and oxygen. Still further advantages may be gained where the thermal energy from said steam loop heated by the syngas stream 28, is used to heat the solid waste stream 22 to reduce the moisture content and improve the quality of the solid waste as a fuel for the gasification process.

The process module 32 further conditions the output fuel stream 34 to have the desired temperature so that it is suitable for downstream use. In one embodiment, the syngas stream 28 exits the gasifier module at a temperature of 700-1000 C. The absorption of thermal energy from the syngas 28 by the oxygen gas stream (through a steam loop) allows the process module to condition the syngas stream for use with clean-up processes that operate at lower temperatures. In some embodiments, these clean-up processes operate at temperatures in the range of 50-450 C. However, as is discussed in more detail herein, in an exemplary embodiment, the downstream process is a power module 38 having a solid oxide fuel cell (SOFC). Since SOFC systems operate at elevated temperatures, such as 700-850 C for example, excess heat 40 from the power module 38 may be transferred into the process module 32 to elevate the output fuel stream 34 to the desired temperature.

It should be appreciated that the synergistic use and transfer of thermal energy and heat transfer mediums between the modules 26, 32, 38 provides advantages in increasing the efficiency and improving the performance of the system 20.

The control system 18 is coupled for communication with one or more of the modules 10, 26, 32, 38 for controlling the operation of the system 20. Control system 18 is only one example of a system that includes automated or manual controls of the system 20 and is not intended to suggest any limitation as to the scope of use or functionality of embodiments described herein. Regardless, control system 18 is capable of being implemented and/or performing any of the functionality set forth hereinabove.

Control system 18 is operational with numerous other general purpose or special purpose computing system environments or configurations. Examples of well-known computing systems, environments, and/or configurations that may be suitable for use with control system 18 include, but are not limited to, programmable logic controllers (PLC), personal computer systems, server computer systems, thin clients, thick clients, cellular telephones, handheld or laptop devices, multiprocessor systems, microprocessor-based systems, programmable consumer electronics, network PCs, minicomputer systems, mainframe computer systems, and distributed cloud computing environments that include any of the above systems or devices, and the like.

Control system 18 may be described in the general context of computer system-executable instructions, such as program modules, being executed by the control system 18. Generally, program modules may include routines, programs, objects, components, logic, data structures, and so on that perform particular tasks or implement particular abstract data types. Control system 18 may be practiced in distributed cloud computing environments where tasks are performed by remote processing devices that are linked through a communications network. In a distributed computing environment, program modules may be located in both local and remote computer system storage media including memory storage devices.

Computer system 18 may be in the form of a general-purpose computing device, also referred to as a processing device. The components of control system may include, but are not limited to, one or more processors or processing units, a system memory, and a bus that couples various system components including system memory to processor. Control system 18 may include a variety of computer system readable media. Such media may be any available media that is accessible by computer system/server, and it includes both volatile and non-volatile media, removable and non-removable media. System memory can include computer system readable media in the form of volatile memory, such as random access memory (RAM) and/or cache memory. Control system 18 may further include other removable/non-removable, volatile/non-volatile computer system storage media.

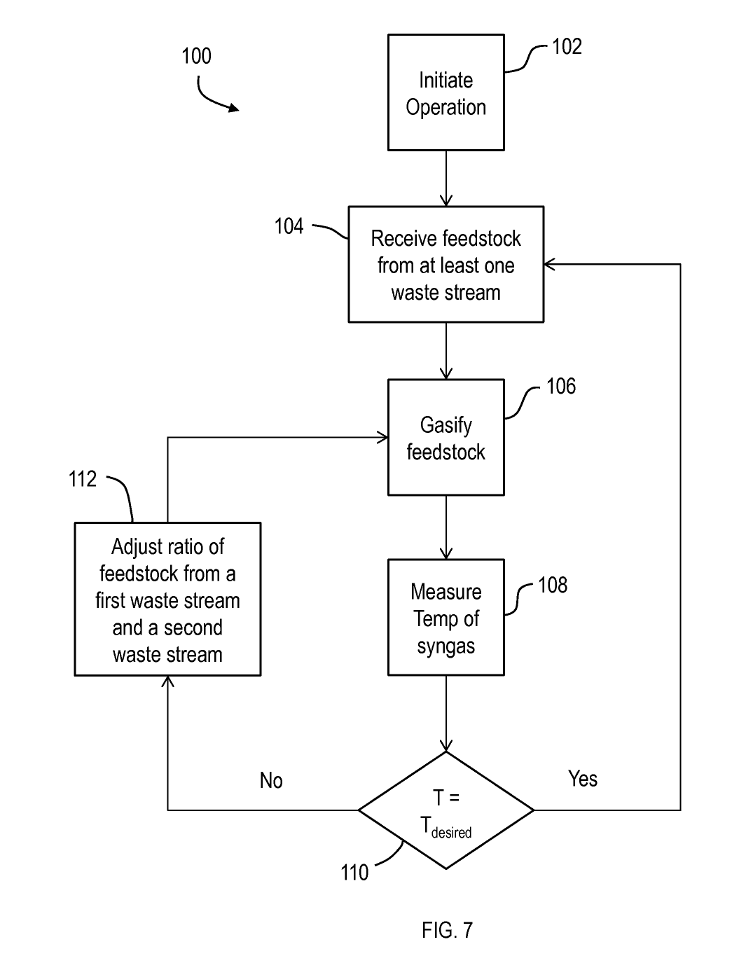

The control system 18 may include a set (at least one) of program modules, may be stored in memory by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein, such as the method illustrated in FIG. 7 for example.

Control system 18 may also communicate with one or more external devices such as a keyboard, a pointing device, a display, etc.; one or more devices that enable a user to interact with a computer system/server; and/or any devices (e.g., network card, modem, etc.) that enable control system 18 to communicate with one or more other computing devices. Such communication can occur via Input/Output (I/O) interfaces. Still yet, control system 18 can communicate with one or more networks such as a local area network (LAN), a general wide area network (WAN), and/or a public network (e.g., the Internet) via network adapter. It should be understood that although not shown, other hardware and/or software components could be used in conjunction with control system 18. Examples include, but are not limited to: analog-to-digital (A/D) converters, microcode, device drivers, redundant processing units, external disk drive arrays, RAID systems, tape drives, and data archival storage systems, etc.

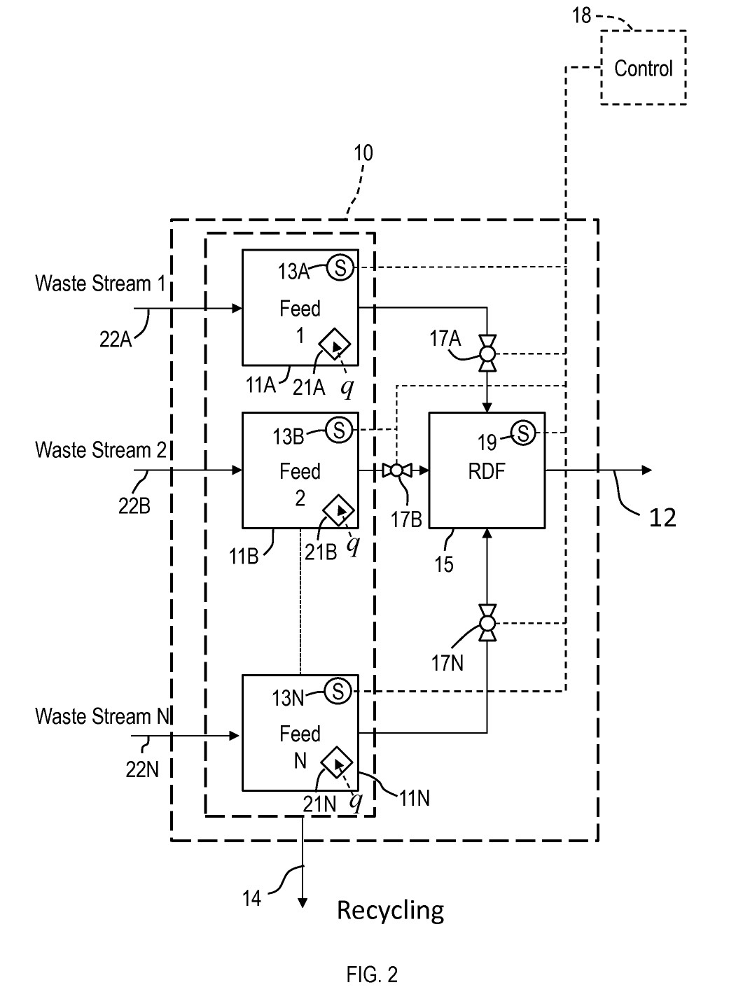

Turning now to FIG. 2, an exemplary feedstock module 10 is shown for combining a plurality of feedstock or waste streams 22A, 22B-22N into a single RDF 12. It should be appreciated that any number of feedstock or waste streams 22 may be input into the feedstock module 10. For exemplary purposes in describing embodiments here, two waste streams 22A, 22B will be described. Each of the waste streams 22A, 22B has a different energy content. As used herein, the term “energy content” refers to the amount of energy (Btu or Kilojoule) per unit of mass (lb or kilogram). For example, the first waste stream 22A may be composed of waste such as municipal solid waste, which typically has an energy content of 4000-8000 Btu/lb (9304-18608 kJ/kg). The second waste stream 22B may be composed of feedstock such as vehicle tires (typical energy content of 14000 Btu/lb or 32564 kJ/kg) that have higher energy content (relative to municipal solid waste). It should be appreciated that these feedstock streams are for exemplary purposes and the claimed invention should not be so limited. In other embodiments, the feedstock module 10 may include any number N feedstock streams, with each feedstock having a different energy content for example. Further, it should be appreciated that the solid waste stream 22A, 22B is not limited to municipal waste and tires, but may include other types of waste such as but not limited to hazardous waste, electronic waste, bio-waste, limestone and coke for example.

The waste streams 22A, 22B are received by receiver modules 11A, 11B. The receiver modules 11A, 11B may include sorters that remove recyclable material (e.g. steel, aluminum) and output a recyclable stream 14. Each of the receiver modules 11A, 11B may include one or more sensors 13A, 13B that are coupled to the control system 18. The sensors 13A, 13B may measure parameters such as feedstock temperature or feedstock water content for example. In one embodiment, the sensors 13A, 13B may include a means for determining the quantity of feedstock available, such as by measuring the feedstock weight or using image analysis for example. The feedstock is then transferred to an RDF module 15 that combines the feedstock and outputs the RDF 12. The RDF module 15 may include one or more sensors 19.

In one embodiment, the amount of feedstock from the receiver modules 11A, 11B being transferred to the RDF module 15 may be controlled via switch modules 17A, 17B. The switch modules 17A, 17B may be connected to the control system 18 to allow the control system 18 to selectively transfer material from the receiver modules based on a desired ratio of feedstocks 22A, 22B. In one embodiment, the control system 18 measures a parameter, such as syngas temperature for example, and changes the ratio of feedstocks input into the RDF module 15 to change an operating condition. As used herein the ratio of feedstocks refers to a quantity of a first feedstock stream to a second feedstock stream that comprises the RDF 12. The quantity may be determined in terms of volume or weight for example.

In one embodiment, rather than or in addition to changing the ratio of the feedstock streams 22A, 22B, the receive modules 11A, 11B may include means for modifying a condition of the feedstock streams 22A, 22B, such as heaters 21A, 21B that increase the temperature of the feedstock streams 22A, 22B to remove water content or dry the feedstock streams. The heaters 21A, 21B may be selectively activated by the control system 18 such as in response to the measurement of an operating parameter. The operating parameter may include the temperature of the syngas 28, or be a parameter associated with the feedstock stream such as but not limited to feedstock water content or humidity levels for example. The thermal energy to operate the heaters 21A, 21B may be received from one or more downstream operations where thermal energy is removed from a gas stream or operating process.

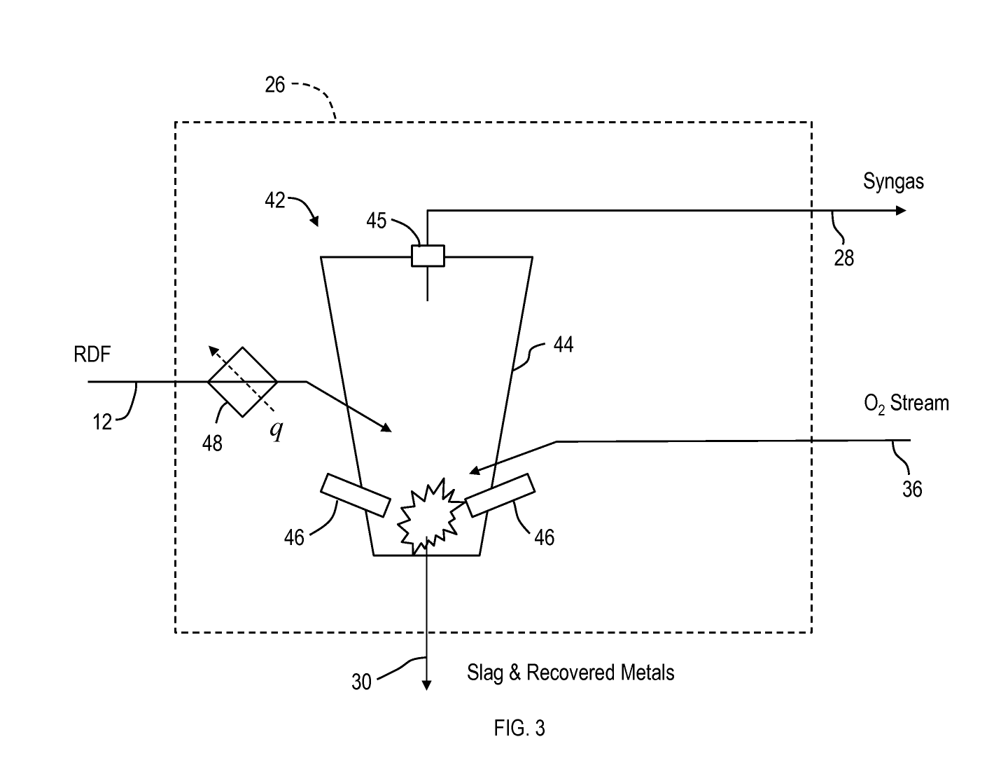

Turning now to FIG. 3, an exemplary gasifier module 26 is shown for converting RDF 12 into a syngas stream 28. In one embodiment, the gasifier module 26 includes a plasma gasifier 42 that is configured to receive the RDF stream 12, the oxygen stream 36 and to output the syngas stream 28 and the residual stream 30. It should be appreciated that while embodiments herein describe the gasifier module 26 as including a plasma gasifier, this is for exemplary purposes and the claimed invention should not be so limited. In other embodiments, other gasifier technologies that are capable of producing syngas at high temperatures (>1000 C) with low tar may be used. In one embodiment, the gasifier produces a syngas with a tar level of less than or equal to 0.5 mole % and preferably between 0.1-0.5 mole %.

In one embodiment, the gasifier 42 includes an inverted frusto-conical shaped housing 44. In one embodiment, the gasifier 42 includes a plurality of plasma torches 46 that are arranged near the bottom end of the housing 44. The plasma torches 46 receive a high-voltage current that creates a high temperature arc at a temperature of about 5,000 C. It should be appreciated that while FIG. 3 illustrates a single point of entry for the RDF 12, the oxygen stream 36 and one pair of plasma torches, this is for exemplary purposes and the claimed invention should not be so limited. In some embodiments there is a plurality of input ports for the streams 12, 36 disposed about the circumference of the housing 44.

A plasma arc gasifier breaks the solid waste into elements such as hydrogen and simple compounds such as carbon monoxide by heating the solid waste to very high temperatures with the plasma torches 46 in an oxygen deprived environment. The gasified elements and compounds flow up through the housing 44 to an output port 45 that fluidly couples the housing 44 to the process module 32. The syngas stream 28 exits the gasifier module 22 at a temperature of about 1,000 C. The residual materials 30, typically inorganic materials such as metals and glasses melt due to the temperature of the plasma and flow out of the housing 44 and are recovered.

In one embodiment, the gasifier module 26 may include a heat transfer element 48 that transfers a portion of the thermal energy “q” from the heat transfer medium to the RDF 12 prior to the RDF 12 entering the plasma gasifier 42. The heat transfer element 48 may be coupled to receive the heat transfer medium from one or more points within the system 20. It should be appreciated that solid waste, such as municipal waste, may have a high moisture content and it may be desirable to lower this moisture content prior to gasification to improve efficiency. Thus the thermal energy q may be used to dry the RDF 12. As discussed herein, in one embodiment, the transfer of thermal energy may be selectively applied to the feedstock streams 22A, 22B via heater 21, such as in response to a signal from one of the sensors 13A, 13B for example.

It has further been found that plasma gasifiers provide advantages over other gasifier technologies since they generate very little tar (mixture of hydrocarbons and free carbon) due to the high temperatures used in operation.

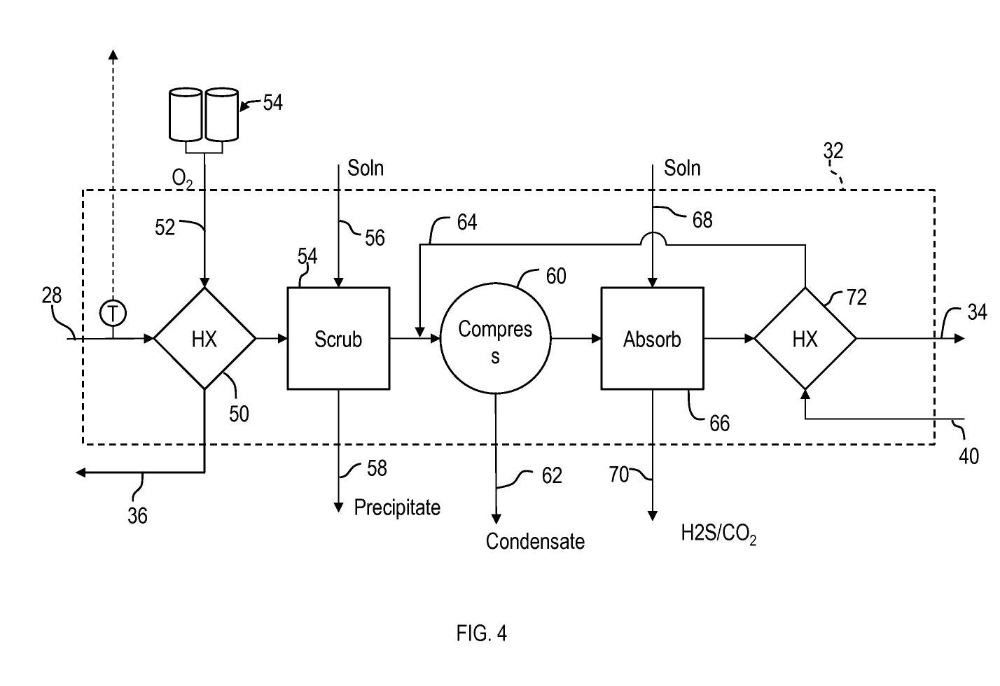

Referring now to FIG. 4, an embodiment is shown of the process module 32. The syngas stream 28 is first received by a heat exchanger 50 that reduces the input temperature from about 1,000 C to about 150 C. The process module 32 may include an initial quench water spray that reduces the initial input temperature from 1,000 C to 850 C. The heat exchanger 50 receives an oxygen gas stream 52 and may also receive water for initial quenching and to be used as a heat transfer medium. In one embodiment the oxygen gas stream 52 is received from a liquid oxygen storage unit 54. The oxygen storage unit 54 may include at least two storage units to allow continuous operation of the system 20 when one of the storage units is empty and being replenished.

The oxygen gas stream 52 absorbs thermal energy from the syngas stream 28 as it passes through the heat exchanger 50. In one embodiment, the heated oxygen stream 36 has a temperature of 200 C at a pressure of 10 atm (about 147 psi or 1 megapascal). It should be appreciated that heating the oxygen to the boiling phase change allows for an increase in pressure without the use of a compressor. Providing the oxygen stream 36 with an elevated pressure level provides advantages in increasing the pressure level of the syngas stream 28. As will be discussed in more detail below, a pressurized syngas stream 28 provides further advantages in allowing certain cleaning processes to operate without the use of secondary compression. It should be appreciated that mechanical compression of the syngas would be a parasitic load on the system 20 that would reduce the overall efficiency. In the exemplary embodiment, the system is configured to provide the oxygen gas stream 52 at a pressure sufficient to provide a syngas stream 28 at the output of the gasification module 26 at a pressure greater than about 140 psi (0.95 megapascal).

The cooled syngas stream 28 flows from the heat exchanger 50 to a first clean-up process module 54. In one embodiment, the first clean-up process module 54 is a scrubber that receives a solvent (typically water) input 56 and precipitates particulates, such as metals (including heavy metals) and dissolves halides and alkali from the syngas stream 28. The first clean-up process module 54 may further remove chlorine from the syngas stream 28. The precipitate stream 58 is captured and removed from the system 20.

In one embodiment, once the particulates and some contaminants are removed, the syngas stream 28 flows to an optional compressor 60 that elevates the pressure of the syngas for further processing. In a system with pressurization achieved by boiling of the liquid oxygen supply, the compressor only needs to drive a recirculation flow through the process and power generation modules. The compressor 60 increases the pressure of the syngas stream 28 to 147 psi (1 megapascal). The compressor 60 may include intercoolers that cause water within the syngas stream to condense out of the gas. This condensate is captured and removed from the system via a condensate trap 62. It should be appreciated that since the syngas stream 28 enters the process module 32 at an elevated pressure the pressurization performed (and the energy used) by the compressor 60 is considerably less than a system where the syngas stream 28 starts at a lower or ambient pressure. It should be appreciated that for a system without a pressurized gas supply, about 22% of the gross electric output would be required to drive a compressor to elevate the syngas pressure from 1 to 10 atm.

In one embodiment, a secondary gas stream 64 is injected into the syngas stream 28 before compression. As will be discussed in more detail below, this secondary gas stream 64 may be received from the anode side of a SOFC. In other words, the secondary gas stream 64 consists of syngas that was not converted by, and subsequently exits, the SOFC and is recycled back into the process module 32. Typically, an SOFC only utilizes about 50% of the incoming fuel. It should be appreciated that advantages are gained by flowing the secondary gas stream 64 prior to compression as the compressor 60 will remove water product from the secondary gas stream and the absorber 66 will remove the CO2 to reduce accumulation of these and other contaminants. Thus only a small amount of nitrogen will accumulate in the system, which may be periodically purged or bled as is known in the art.

Once the syngas stream 28 has been compressed, the stream enters a second clean-up process module 66. In one embodiment, the second clean-up process module 66 is an amine based absorber that uses an input solvent 68 such as monoethanolamine (MEA) that absorbs and removes contaminants such as carbon dioxide and sulfur (typically as H2S) from the gas stream. These contaminants are captured and removed via a contaminant stream 70.

In the exemplary embodiment, the power module 38 includes a SOFC. In one embodiment, the SOFC may have a power rating of about 15 MW. These fuel cells operate at elevated temperatures in the range of 700-1,000 C. Since the sub-processes of the process module 32 operate at lower temperatures (50-150 C), a heat exchanger 72 receives the cleaned syngas steam and increases the temperature to a desired temperature, such as above 700 C for example. In the exemplary embodiment, the heat transfer medium 40 is the secondary gas stream 64 received from the SOFC. Thus the heat exchanger 72 provides advantages in both increasing the temperature of the syngas stream from the process module 66 to the desired operating temperature and reducing the temperature of the secondary gas stream 64 to a temperature compatible with the sub-processes of the process module 32. In one embodiment, the secondary gas stream enters the heat exchanger 72 at 850 C and exits at 150 C.

With the temperature of the syngas increased to the desired temperature, the output fuel stream 34 exits the process module 32. It should be appreciated that the process module 32 may include additional processing modules to condition the output fuel stream 34, such as humidifiers for example.

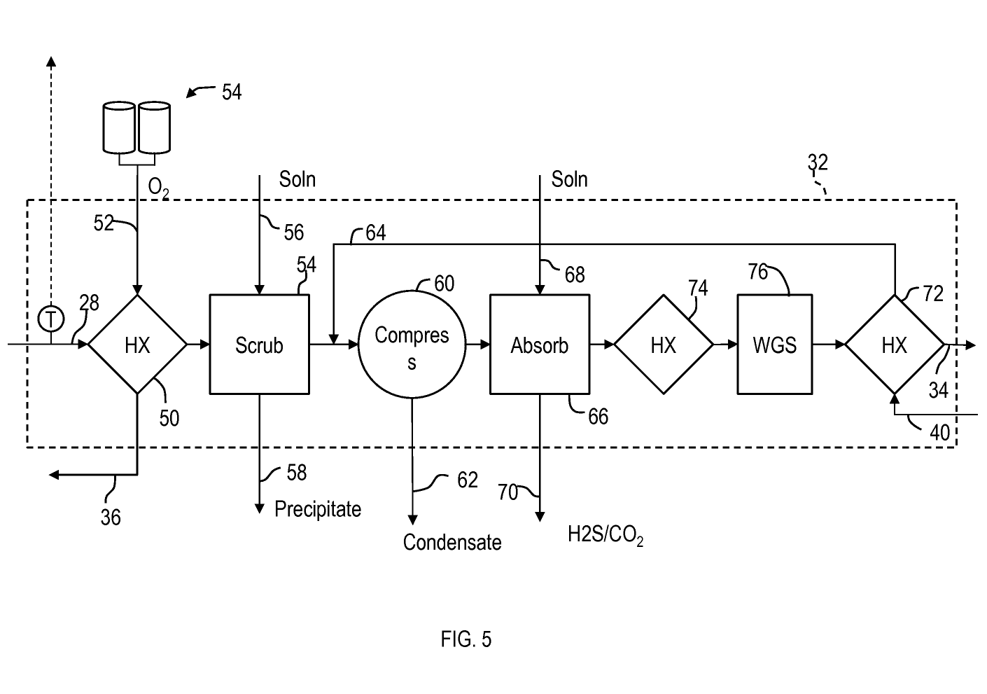

Turning now to FIG. 5, another embodiment is shown of a process module 32. This embodiment is similar to the embodiment of FIG. 4 with an added sub-process module to further enhance the hydrogen content of the syngas stream through the reduction of carbon monoxide. In this embodiment, the syngas stream 28 exits the absorber process module 66 and enters heat exchanger 74 that increases the temperature of the syngas to 250-350 C

With the temperature of the syngas stream 28 at the desired operating temperature, the syngas enters a water-gas shift module 76. In a water-gas shift reaction the syngas is exposed to a catalyst, such as iron oxide-chromium oxide or a copper-based catalyst for example. The water-gas shift module 76 reduces the carbon monoxide content of the syngas stream to less than or equal to 10 percent by converting it with water vapor to additional hydrogen and carbon dioxide. In one embodiment, the water-gas-shift module 76 includes multiple-stages that operate in the 150-450 C temperature range. Each of these stages may be exothermic and additional heat exchangers may be used to remove thermal energy between each stage. It should be appreciated that different catalysts may be used in different stages of the water-gas shift module 76. The extracted thermal energy may be either transferred to the environment or in some embodiments transferred to other portions of the system 20, such as the heat exchanger 72 or for drying one or more of the solid waste streams 22A, 22B for example. In one embodiment, the thermal energy is used to drive one or more small gas turbines.

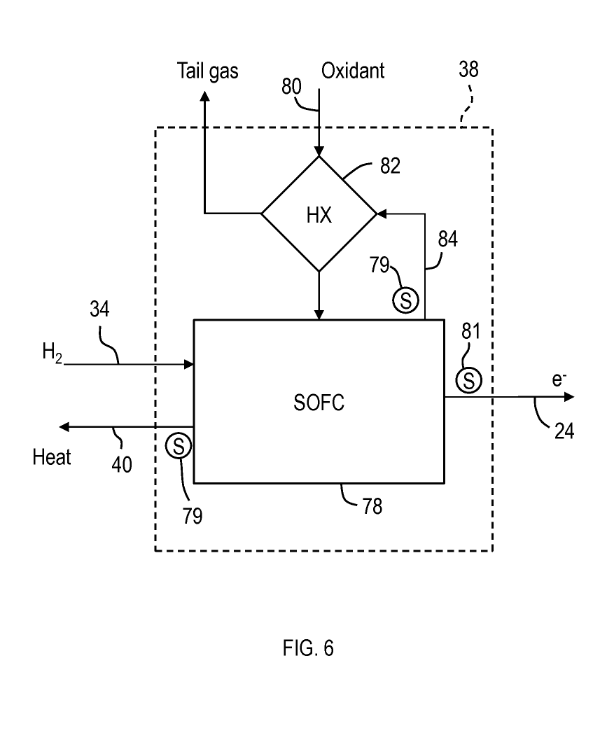

Referring now to FIG. 6, an exemplary power module 38 is shown having a SOFC 78. It should be appreciated that while embodiments herein describe the power module 38 as having a SOFC, this is for exemplary purposes and the claimed invention should not be so limited. In other embodiments, the module 38 may be used to drive other electrical generation systems, such as a steam generator that cooperates with a gas turbine or by directly converting the syngas by combustion in an internal combustion engine drive generator for example. In still other embodiments, the module 38 includes a Fischer-Tropsch process sub-module that outputs liquid hydrogen.

The output gas stream 34 enters the power module 38 and is received by the SOFC 78. A SOFC is an electrochemical conversion device that generates electrical power by the direct oxidation of a hydrogen based fuel. The SOFC uses a solid oxide material as an electrolyte to conduct oxygen ions from a cathode to an anode. The SOFC operates at very high temperatures, typically 700-1,000 C. Thus, the system 20 provides advantages in that the output gas stream 34 may be delivered from the process module 32 at or nearly at the operating temperature of the SOFC.

To produce electrical power 24, the SOFC 78 receives an oxidant, such as air as an input 80 that passes through a heat exchanger 82 where the temperature of the oxidant is increased. The heat exchanger 82 is fluidly coupled to receive cathode tail gas 84 that has been heated by the operation of the SOFC 78. The tail gas 84 passes through the heat exchanger 82 and then exits the system.

It should be appreciated that not all of the hydrogen and CO in the output gas stream 34 may be consumed during operation. During operation, the output gas stream 34 enters the anode side of the SOFC 78 where, in the presence of an anode catalyst, some of the hydrogen combines with the oxygen ions that migrated through the electrolyte. This exchange releases electrons and produces water. Water gas shift reactions also occur within the anode transforming CO and water vapor to CO2 and hydrogen. The water, CO2 and any unused fuel from the output gas stream exits the anode. This excess fuel stream 40 exits at or nearly at the operating temperature of the SOFC 78. As discussed herein, this fuel stream passes through the heat exchanger 72 to preheat the output gas stream 34 and is subsequently recycled back into the process as the secondary gas stream 64.

In one embodiment sensors 79 may be arranged adjacent output of at least one of the anode or cathode of the SOFC 78. The sensors 79 may measure an operating parameter, such as temperature for example and transmit a signal to the control system 18. In one embodiment, a sensor 81 may be arranged to measure the electrical power output of the SOFC 78 and provide a feedback signal to the control system 18.

Referring now to FIG. 7, a method 100 of operating the system 20 using a closed loop feedback control circuit to adjust the temperature of the syngas. The method 100 starts in block 102 where operation of the system 20 is initiated. The method 100 then proceeds to block 104 where feedstock is received, such as with receiver modules 13A, 13B for example, from one or more waste streams 22A, 22B. It should be appreciated that at the start of operation, the system 20 may use feedstock from just one waste stream or from a plurality of waste streams depending on the initial conditions, the amounts available and the quality of the waste streams 22A, 22B. The RDF 12 is then transferred to the gasifier module 26 and the feedstock gasified in block 106. The syngas 28 generated by the gasifier 42 is transferred to the process module 32 where the temperature of the syngas 28 is measured with a sensor 16 in block 108. In one embodiment, the measured parameter is the temperature of the output of the SOFC 78, such as either the anode gas 40 or the cathode gas 84.

It should be appreciated that it is desirable to operate the system 20 to have a temperature of the syngas 28 within a desired temperature range. If the temperature is too low or too high, then the downstream processes may not operate as efficiently as desired. The temperature of the syngas 28 may be affected by the quality or energy content of the input waste streams. Higher energy waste streams (e.g. tires) allow the generation of syngas at higher temperatures than lower quality or lower energy waste streams (e.g. municipal solid waste).

In query block 110, the measured temperature T is compared to a desired temperature T_{desired}. It should be appreciated that the desired temperature may be a threshold (e.g. above or below as specific value) or may be a range of values (e.g. between a lower and upper threshold). If the query block 110 returns a positive, the method 100 loops back to block 104 and the operation of the system 20 continues. If query block 110 returns a negative, meaning the temperature is not within a predefined value, then the method 100 proceeds to block 112. In block 112, the ratio of the feedstock from two or more different waste streams is changed to adjust the temperature of the syngas 28. For example, if the temperature of the syngas 28 is lower than desired, then the amount of, or the ratio of, feedstock from a higher energy waste stream (e.g. tires) may be increased, resulting in an increased temperature of the syngas 28. If the temperature of the syngas is higher than desired, then the amount of, or the ratio of, feedstock from a lower energy waste stream (e.g. municipal solid waste) may be increased. This in turn would lower the temperature of the syngas 28 produced in the gasifier 42. In one embodiment, the method 100 may further change other variables within the system, such as the feed rate of the feedstock, the plasma torch input power or the flow of the oxidant (0₂). It should be appreciated that the method 100 may adjust all of these parameters or just one of the parameters to achieve the desired temperature. With the feedstock adjusted, the method 100 loops back to block 106 and the process continues.

In one embodiment, rather than or in addition to changing the ratio of the feedstock streams 22A, 22B, the method 100 may activate one or more of the heaters 21A, 21B or heat transfer element 48 to dry or reduce the water content of the feedstock streams 22A, 22B or RDF 12.

It should be appreciated that the control system 18 may incorporate additional variables into the adjustment of the feedstock, such as from sensors 13A, 13B, 19 for example. In this embodiment, the adjustment of the feedstock ratios may factor for variables that include and are not limited to: the type of waste stream, the water content of the waste stream, the volume of waste stream available and the temperature of the waste stream for example.

It should be appreciated that embodiments of the invention provide advantages in allowing the gasification of solid waste to produce electrical power. Embodiments of the invention allow for the increase in efficiency of the system by utilization of the thermal energy generated during operation that would normally be dissipated in the ambient environment to enhance operation, such as by drying the solid waste stream or conditioning the input fuel stream to a solid oxide fuel cell. Still further embodiments of the invention provide advantages in increasing the pressure of the oxygen entering a gasifier using heat from the gasifier output stream. This pressurized oxygen provides a desired pressure increase in the gasifier output stream that reduces or eliminates the use of downstream compressors to further increase the efficiency of the system.

The term “about” is intended to include the degree of error associated with measurement of the particular quantity based upon the equipment available at the time of filing the application. For example, “about” can include a range of ±5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A system for converting solid waste material to a syngas comprising:
a feedstock module configured to receive at least a first feedstock stream and a second feedstock stream, the second feedstock stream being different than the first feedstock stream, the feedstock module being further configured to mix the first feedstock stream and the second feedstock stream at a first ratio to produce a first refuse derived feedstock;
an input module having a low tar gasification generator configured to produce a first gas stream in response to receiving the refuse derived feedstock, the first gas stream including hydrogen;
a process module fluidly coupled to receive the first gas stream, the process module including at least one clean-up process module configured to remove at least one contaminant from the first gas stream and produce a second gas stream containing hydrogen;
a first sensor arranged to measure a first operating parameter; and
a control system coupled for communication to the feedstock module and the sensor, the control system having a processor responsive to executable computer instructions for changing the ratio of the first mixture of the first feedstock stream to the second feedstock stream to a second ratio in response to receiving the first parameter.

2. The system of claim 1, wherein the first operating parameter is a temperature of the syngas entering the process module.

3. The system of claim 2, wherein the second feedstock stream has a higher energy content than the first feedstock stream.

4. The system of claim 3, wherein the temperature is equal to or below a threshold and the second ratio includes a larger quantity of the second feedstock stream than the first ratio.

5. The system of claim 3, wherein the temperature is equal to or above a threshold and the second ratio includes a larger quantity of the first feedstock stream than the first ratio.

6. The system of claim 2, wherein the second feedstock stream has a lower energy content than the first feedstock stream.

7. The system of claim 6, wherein the temperature is equal to or below a threshold and the second ratio includes a larger quantity of the first feedstock stream than the first ratio.

8. The system of claim 6, wherein the temperature is equal to or above a threshold and the second ratio includes a larger quantity of the second feedstock stream than the first ration.

9. The system of claim 1, further comprising a hydrogen conversion device fluidly coupled to receive the second gas stream, the hydrogen conversion device being configured to generate an output in response to receiving the second gas stream.

10. The system of claim 9, wherein the first sensor is operably coupled to the output.

11. The system of claim 10, wherein the first operating parameter is a temperature of the output.

12. The system of claim 11, wherein the output is a gas stream exiting an anode side of a fuel cell.

13. The system of claim 11, wherein the output is a gas stream exiting a cathode side of a fuel cell.

14. The system of claim 10, wherein the output is electrical power.

15. The system of claim 10, wherein the output is liquid hydrogen.

16. The system of claim 1, further comprising a second sensor operably coupled to the first feedstock stream and a third sensor operably coupled to the second feedstock stream, the second sensor is configured to measure a second operating parameter of the first feedstock stream and the third sensor is configured to measure a third operating parameter of the second feedstock stream, the second sensor and the third sensor being coupled to communicate with the control system.

17. The system of claim 16, wherein the processor is further responsive to change the ratio of the first mixture of the first feedstock stream to the second feedstock stream to the second ratio in response to the receiving at least one of the second operating parameter and third operating parameter.

18. The system of claim 17, wherein the second operating parameter is selected from a group comprising: feedstock temperature, feedstock water content, feedstock weight and a volume of feedstock based at least in part on image of the feedstock.

19. A method of producing syngas from a solid waste stream comprising:
receiving a first feedstock stream;
receiving a second feedstock stream;
mixing the first feedstock stream and the second feedstock stream to generate a refuse derived feedstock (RDF) stream, the RDF stream having a first ratio of the first feedstock stream to the second feedstock stream;
transferring the RDF stream into a gasification generator;
receiving an oxygen gas stream at the gasification generator;
producing a first gas stream and residual materials using the gasification generator;
measuring a first operating parameter associated with the first gas stream; and changing the first ratio in response to measuring the first operating parameter.

20. The method of claim 19, wherein the step of measuring the first operating parameter is performed adjacent the exit of the gasification generator.

21. The method of claim 20, wherein the first operating parameter is a temperature of the first gas stream.

22. The method of claim 19, further comprising:
removing at least one contaminant from the first gas stream to generate a second gas stream;
receiving the second gas stream in a hydrogen conversion device; and
generating an output with the hydrogen conversion device.

23. The method of claim 22, wherein the measuring of the first operating parameter is performed on the output.

24. The method of claim 23, wherein hydrogen conversion device is a fuel cell and the output is an anode gas stream.

25. The method of claim 23, wherein the hydrogen conversion device is a fuel cell and the output is a cathode gas stream.

26. The method of claim 23, wherein the hydrogen conversion device is a fuel cell and the output is electrical power.

27. The method of claim 23, wherein the hydrogen conversion device is a Fischer-Tropsch process and the output is liquid hydrogen.

28. The method of claim 19, further comprising:
measuring a second operating parameter associated with the first feedstock stream; and
wherein the step of changing the first ratio is in response to the measuring of the first operating parameter and the second operating parameter.

29. The method of claim 28, wherein the second operating parameter is selected from a group comprising: feedstock temperature, feedstock water content, feedstock weight and a volume of feedstock based at least in part on image of the feedstock.
